(19) United States
(12) Patent Application Publication
(10) Pub. No.: US 2007/0201828 A1
(43) Pub. Date: Aug. 30, 2007

(54) Method and device for generating a menu

(76) Inventors: Cheng Tao, Singapore (SG); Chiew Mun Chang, Singapore (SG); Kwong Heng Kwok, Singapore (SG)

Correspondence Address: JOSEPH J. LAKS, VICE PRESIDENT;THOMSON LICENSING LLC, PATENT OPERATIONS, PO BOX 5312, PRINCETON, NJ, 08543-5312, US

(21) Appl. No.: 10/594,862

(22) PCT Filed: Mar. 19, 2005
(86) PCT No.: PCT/EP05/02965

§ 371 Date: Sep. 29, 2006

(30) Foreign Application Priority Data
Apr. 2, 2004 (EP) 04300178.3

(51) Int. Cl. H04N 7/00

(52) U.S. Cl. 386/95; 375/240.26

(57) ABSTRACT

The invention relates to method and device for generating a menu for video recording, and to recording medium carrying such menu; wherein the menu is coded according to an MPEG like standard, and a menu is divided into an I-picture for the menu background and a P-picture for only the thumbnail(s) of recordings. A menu is updated with information related to an additional recording on the recording medium by generating a P-picture having changes only for selected blocks containing picture information representative of the additional recording.

The invention refers to a method and a device for generating a menu for a video recording medium, wherein the menu is coded according to an MPEG like standard. Such MPEG like standard is for example known as MPEG-1, MPEG-2 but similar encoding methods exist that also use base pictures and predicted pictures based on the base pictures.

In known devices for generating a menu for video recordings, menu encoding is done by a hardware encoder. This may be seen to have the disadvantage that during the encoding a live picture can not be presented because there is only one encoder available in the device.

In other known devices for generating a menu for video recordings the menu is encoded as one independently encoded picture by a software encoder. In this case a live picture can be presented during the menu generation, but it may be seen to have the disadvantage that it takes at least 30 secs to encode a menu including a logo and thumbnail(s) of recordings, and the user can't access the recording medium or a tray holding it during this time.

It is an object of the invention to propose an improved method and device for generating a menu for video recordings.

According to the invention, menus are divided into two pictures, namely an I-picture or independently coded picture for the menu background and a P-picture or predictively coded picture for only the thumbnail(s) of recordings.

A method according to the invention starts with a predefined intra-coded picture that consists of blocks and generates an inter-coded picture, where the inter-coded picture contains no change information for predefined blocks while it contains change information for selected blocks. The selected blocks contain picture information that is representative of recordings on the recording medium. Both, the intra-coded picture and the inter-coded picture are taken as menu information and stored accordingly on the recording medium.

Intra-coded pictures are often referred to as I-pictures while inter-coded pictures are usually referred to as P-pictures. An inter-coded picture is based on a preceding intra-coded picture and contains just the change information between these two pictures.

An advantage of the inventive method is that no time is needed for encoding the predefined picture. The predefined picture is preferably the background of the menu as for example a company logo, a user defined picture or the like. The only time to be spent is for encoding a small number of selected blocks that contain the information representative of a recording on the recording medium. This allows to quickly finish the menu and thus to use a comparatively slow or low performance encoder without negative effect to the user.

Preferably, the picture information representative of more than one recording is used for generating the inter-coded picture. If a menu contains several recordings, smaller block areas for each recording are used. This has the advantage that a menu for several recordings is generated in about the same time as for one or a very small number of recordings.

According to the invention a menu is updated with information related to an additional recording on the recording medium by generating an inter-coded picture having changes only for selected blocks containing picture information representative of the additional recording. Selected blocks are for example selected for recording 1, recording 2 and so on, which are displayed on the same menu. Changes to the content of the recording medium that suggest a menu updating comprise adding or removing a recording or replacing the representative picture information for one recording by a different one for example one selected by the user.

Advantageously, an inter-coded picture is added to the previous inter-coded picture. It may either replace the previous inter-coded picture with the new one or combine the previous inter-coded picture with the new one or add the new one as a further picture.

A device for generating a menu for a video recording medium comprises a predefined intra-coded picture memory, a representative picture memory, and an encoder for generating an inter-coded picture using an output of the intra-coded picture memory as basis and an output of the representative picture memory as change information to be encoded. This has the advantage of time saving as the predefined basis picture is already encoded and only differences need to be encoded. For this not much encoding capacity is needed.

Preferably, the device according to the invention is provided with a fast encoder and a slow encoder wherein the slow encoder is used for menu generation and the fast encoder is used for encoding a moving video sequence. The slow encoder preferably is represented by software while the fast encoder preferably is represented as hardware. One advantage is that the fast encoder is enabled to work uninterrupted by the menu generation, e.g. for providing a display device with moving image information or for providing a recording device with encoded moving image information while the slow encoder performs the menu generation concurrently but independently. Thanks to the time saving of the invention even the menu generation by the slow encoder does not give the user the feeling of low speed performance.

A recording medium according to the invention has recorded on it one or several recordings like videos, still pictures, audio sequences etc., and a, menu recording for information about at least one recording. The- menu recording comprises a predefined intra-coded picture, which is the same for every recording medium generated by the same recording device, and at least one inter-coded picture having difference information only for selected areas, wherein the difference information is related to picture information representative of a recording. That means the inter-coded picture contains change information only for certain areas, for example a certain range of blocks, and differences exist only there. The differences refer to one or several picture information representative of a recording on the recording medium.

More details and advantages of the invention will become apparent from the following description.

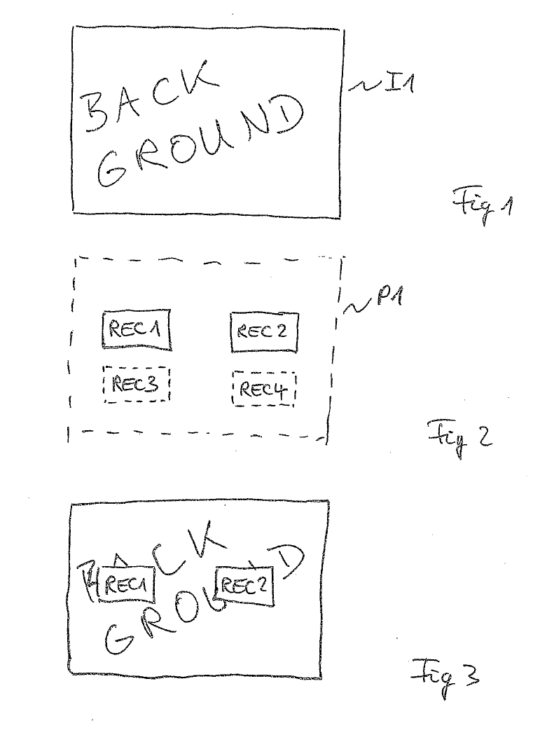

FIGS. 1 to 3 show examples of pictures used for menu generation,

FIG. 4 shows a device according to the invention, and

FIG. 5 shows a recording medium according to the invention.

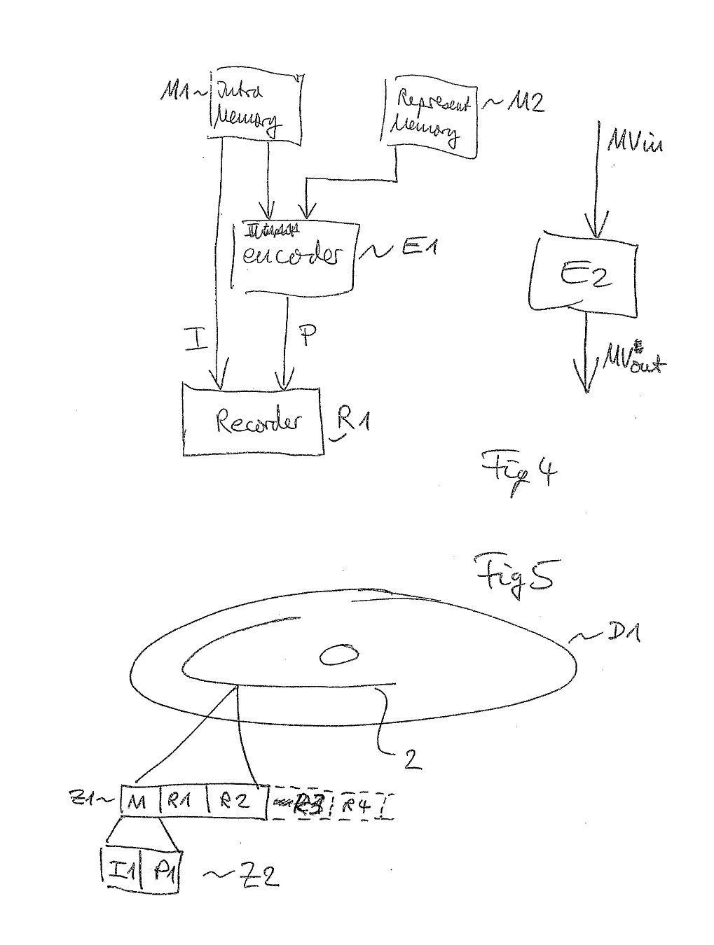

In known systems, an MPEG encoder is used to encode a menu as shown in FIG. 3 that includes a background and thumbnails of recordings. Such method is called hardware encoding because it is done using the MPEG encoder hardware. Hardware encoding comprises stopping to encode a live picture, using the MPEG encoder to encode one still picture, and resuming to encode the live picture. Disadvantages of hardware encoding are that when the MPEG encoder is stopped, the live picture will be frozen, and the user can't view the live video. Also, sometimes the encoder can't be stopped properly, the still picture can't be encoded, and the user, despite seeing a title of a recording in the title list, can't see this recording in the menu. Also, even if the still picture is successfully encoded, a few seconds of live picture are lost, and user will feel pain if the end of story is shown during these few seconds.

In other known systems, software encoding is used to encode a menu as shown in FIG. 3 that includes a background and thumbnails of recordings. The menu is encoded as a single I-picture and each time after a new recording has been done encoding comprises applying DCT and quantization to all video blocks. Disadvantages of single I-frame software encoding are that with the large number of calculations involved and with host CPUs of the systems being not so fast, the speed of encoding the menu is obviously slow compared to hardware encoding.

With this invention, the software encoding is used to encode the menu in a way that, although the menu includes a background and thumbnails of recordings, only thumbnails are encoded when a new recording is done. FIGS. 1-3 show the structure of the menu according to this invention.

FIG. 1 shows an example of a predefined intra-coded picture I1 being indicated as “background”.

FIG. 2 shows an inter-coded picture PI containing change information only in selected blocks REC1 and REC2. It indicates further possible selected blocks REC3, REC4. Selected blocks REC1 and REC2 contain picture information representative of two recordings on a recording medium. Selected blocks REC3, REC4 are intended to contain picture information representative of future recordings on the recording medium.

FIG. 3 shows a menu comprising a menu background and selected blocks REC1, REC2 containing picture information representative of two recordings on a recording medium.

The P-picture software encoding according to this invention comprises the following steps: The background picture is considered as I-picture in the menu, so it takes no time to encode it. Because the background picture is a still picture in MPEG format, it is usually stored in static memory. The thumbnail of a new recording is considered as P-picture. It only takes time to encode the difference between the background and the menu, which is the thumbnail(s). Hence, DCT and quantization are applied only to video blocks of thumbnail(s) when the new recording is done.

The advantages are that a live picture is still there after the new recording is done because there is no need to stop the hardware MPEG encoder to encode the still picture, and that this method is faster than normal single I-frame software encoding, and that users can see a live picture during menu generation if the recorder is in “live” mode whereas known devices do not show a live picture during menu generation, and that it takes a shorter time to software encode the menu because I-frame (background) is always the same in every menu and only P-frame is software encoded after a new recording has been done.

Advantageously, for the generation of the thumbnail REC3 of a new recording, any extra picture decoding is avoided if, during the new recording, the first complete picture in an encoder reference memory is duplicated into a special, dedicated extra memory area, and if, after the new recording, the picture in the extra memory area is subsampled into a thumbnail size.

FIG. 4 schematically shows important elements of a device according to the invention. A memory M1 is provided for storing one or several intra-coded pictures I1 while a memory M2 is provided for storing picture information representative of one or several recordings on the recording medium. An encoder E1 uses the intra-coded picture from memory M1 and the representative picture information from memory M2 to calculate the inter-coded picture P1. This calculation refers only to the selected blocks shown as RECI and REC2 in FIG. 2 for the example of two recordings. The calculated inter-coded picture P1 is transmitted via a line P to a recorder R1 that also receives the intra-coded picture I1 via line I for recording both as menu information on a recording medium.

The encoder E1 is a slow encoder, for example a software encoder, while another encoder E2 is a fast encoder preferably a dedicated encoder IC that receives moving video input MVin to be encoded and outputs encoded moving video information MVout. As can be seen, both encoders E1, E2 work in parallel and independently of each other.

FIG. 5 shows diagrammatically a recording medium as an optical disk D1 having a track 2 containing recordings as indicated in the zoomed area Z1 showing a recorded menu M, a first recording R1 and a second recording R2. Possible future recordings R3, R4, are indicated by dashed lines. A second zoom area Z2 shows that the menu is provided with an intra-coded picture I1 and an inter-coded picture P1. It is to be understood, that this schematic figure shows only very few details relevant to the invention.

1. Method for generating a menu for a video recording medium, the menu being coded according to an MPEG like standard, the method having the steps of
starting with a predefined intra-coded picture consisting of blocks,
generating an inter-coded picture having no change information for predefined blocks, and having change information for selected blocks containing picture information representative for a recording on the video recording medium, and
using both, the inter-coded picture and the intrainter-coded picture as menu information.

2. Method according to claim 1, wherein picture information representative for more than one recording is used for generating the inter-coded picture.

3. Method according to claim 1, wherein the menu is updated with information related to another recording on the video recording medium by generating an inter-coded coded picture shaving changes only for selected blocks containing picture information representative for the respective recording.

4. Method according to claim 1, wherein an inter-coded picture is added to the previous inter-coded picture.

5. The method of claim 1, where for generating the picture information representative for a new recording, a picture from an encoder display buffer is duplicated into an extra memory area during the new recording, and the picture in the extra memory area is subsampled after the new recording has been terminated.

6. Device for generating a menu for a video recording medium, the menu being coded according to an MPEG like standard, the device having a predefined intra-coded picture memory, a representative picture memory, an encoder for generating an inter-coded picture using an output of the intra-coded picture memory as basis and an output of the representative picture memory as changes to be recorded, and a recording unit.

7. Device according to claim 6, wherein is provided a fast encoder and a slow encoder, the slow encoder being used for menu generation and the fast encoder being used for encoding a moving video sequence.

8. The device of claim 7, where the fast encoder has a display buffer, the device additionally has an extra memory area and is equipped and arranged to copy, during recording, a picture from the display buffer into the extra memory area, and to subsample, after the recording, the picture in the extra memory area into a picture information representative for the new recording.

9. Recording medium D1 having recorded on it one or more recordings and a menu for information about the one or more recordings, wherein the menu comprises a predefined intra-coded picture and at least one inter-coded picture having difference information only for selected areas, the difference information being related to picture information representative for a recording.
